(19) United States
(12) Patent Application Publication
(10) Pub. No.: US 2005/0122862 A1
(43) Pub. Date: Jun. 9, 2005

(54) Tracking servo control apparatus and method using rotatable grating

(75) Inventors: Dong-Ik Shin, Kyunggi-do (KR); Won-Jae Hwang, Seoul (KR); Chon-Su Kyong, Seoul (KR); Sung-Kyun Park, Kyunggi-do (KR); Ho-Cheol Lee, Seoul (KR); Ho-Seop Jeong, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/920,106

(22) Filed: Aug. 17, 2004

(30) Foreign Application Priority Data
Dec. 9, 2003 (KR) 2003-93761
Mar. 3, 2004 (KR) 2004-14381

(51) Int. Cl. G11B 7/00

(52) U.S. Cl. 369/44.41; 369/44.37

(57) ABSTRACT

A tracking servo control apparatus and method in which the distance between a main beam and a side beam is adjustable by a rotatable grating, so as to perform a tracking servo control operation in accordance with a differential push-pull (DPP) method for both the DVD-ROM (Read Only Memory) and the DVD-RAM (Random Access Memory) having different track pitches.

### BACKGROUND OF THE INVENTION

1. Field of the Invention

The present invention relates to a tracking servo control apparatus and method using a rotatable grating, and more particularly to a tracking servo control apparatus and method capable of compensating for an offset, which is involved in push-pull signals generated in accordance with detection of side beams, due to rotation of a grating, during a tracking servo control operation using a differential push-pull (DPP) method.

2. Description of the Related Art

In pace with recently increased use of large-capacity data, development of optical discs which use a particular optical system to achieve recording of data thereon and reproduction of data recorded thereon has been increased. Specifically, in such a optical disc, recording of data is carried out by varying the transmittance, reflectance, phase, and polarity of light to be irradiated onto a data area of the optical disc in accordance with the data, whereas reproduction of the recorded data is carried out by reading the optical variation corresponding to the recorded data, using light.

Such an optical disc has a circular plate structure, on which various information areas are defined. Upon recording data on the optical disc, pits, which have a size corresponding to the wavelength of light, are formed on a data area of the optical disc as a focused laser beam is irradiated onto the data area in accordance with the data. When a focused laser beam is irradiated onto the data area to reproduce data recorded on the data area, it is reflected from the data area while exhibiting a particular reflectance, phase or polarity in accordance with whether or not there is a pit on a region where the laser beam is irradiated. Based on the exhibited reflectance, phase or polarity, that is, whether or not there is a pit at the region where the light beam was irradiated, a digital signal having a logic value of “1” or “0” is generated.

A variety of optical discs have been developed. For example, optical discs are classified into a compact disc (CD) and a digital video disc or a digital versatile disc (DVD). CDs are classified into a CD read-only disc (CD-ROMs, and a CD recordable disc (CD-R), and a CD rewritable disc (CD-RW). On the other hand, DVDs are classified into a DVD read-only (DVD-ROM) single layer, a DVD-ROM dual layer, a DVD recordable disc (DVD-R), a DVD rewritable disc version 1.0 (DVD-RAM1), DVD rewritable disc version 2.0 (DVD-RAM2), a DVD re-recordable disc (DVD-RW), and a DVD rewritable (DVD+RW) (a rewritable DVD standard established by six companies, that is, Sony Company, Ltd., Phillips Electronic Company, Hewlett-Packard Company, Mitsubishi Chemical Company, Ltd., Ricoh Company, Ltd., and Yamaha Company, Ltd., and also called “PC-phase change rewritable (PC-RW)”).

FIG. 1 is a block diagram illustrating a basic configuration of a general optical disc recording/reproducing apparatus adapted to record data on a general optical disc, and to reproduce the recorded data.

Referring to FIG. 1, an optical pickup 102 is shown which operates to position, on a signal track formed at a signal recording surface of an optical disc 101, the spot of a light beam focused by an objective lens, under the control of a servo control unit 104. The light beam is reflected from the signal recording surface of the optical disc 101, and is then incident to a photodetector after being focused by the objective lens. The photodetector serves to detect a focus error signal and a tracking error signal from the light beam incident thereto.

The photodetector includes a plurality of photodetecting elements. An electrical signal proportional to the amount of light detected by each photodetecting element is applied to an RF and servo error generating unit 103.

The RF and servo error generating unit 103 detects an RF signal for reproduction of data, a focus error signal FE and a tracking error signal TE for servo control, from the electrical signal outputted from each photodetecting element of the photodetector.

The detected RF signal is sent to a data decoder (not shown) for reproduction of data, whereas the servo error signals such as the focus and tracking error signals FE and TE are sent to the servo control unit 104.

The servo control unit 104 processes the focus error signal FE, thereby outputting a drive signal for focusing control to a focusing servo driving unit 105. The servo control unit 104 also processes the tracking error signal TE, thereby outputting a drive signal for tracking control to a tracking servo driving unit 106.

The focusing servo driving unit 105 drives a focus actuator included in the optical pickup 102, so that the optical pickup 102 is vertically moved to follow a vertical movement of the optical disc 101 carried out during a rotation of the optical disc 101.

The tracking servo driving unit 106 drives a tracking actuator included in the optical pickup 102, so that the objective lens of the optical pickup 102 is moved in a radial direction to correct the position of the beam spot, so as to allow the light beam to accurately trace a desired track.

Where it is desired to move the entire portion of the optical pickup 102, a sled servo driving unit 107 receives a sled control signal from the servo control unit 104 to drive a sled motor 108. In accordance with the operation of the sled motor 108, it is possible to directly feed the body of the optical pickup 102 in a desired direction.

For the tracking control carried out by the RF and servo error generating unit 103 and servo control unit 104 for optical discs of the CD and DVD series, there may be various methods, for example, a three-beam method, a push-pull (PP) method, a differential phase detection (DPD) method, and a differential push pull (DPP) method.

FIG. 2 illustrates a signal recording surface of a general optical disc. As shown in FIG. 2, information is recorded on a disc-shaped substrate 201 along tracks 203. The information can be reproduced by irradiating, onto the substrate 201, a laser beam 205 focused through an objective lens, and reading a variation in the reflectance, phase or polarity of a beam reflected from the substrate 201.

In order to record a large amount of high definition (HD) image data corresponding to a playback time of 2 hours or more, it is necessary to use a recording medium having a recording capacity of about 15 GB. However, the maximum recording capacity of high density DVDs, which are currently available, is only about 4.7 GB.

Recording of data at a higher recording density on a disc may be achieved by reducing the distance between adjacent tracks of the disc, on which data is recorded, that is, a track pitch. However, there may be a limitation in reducing the track pitch because crosstalk may be generated during playback of the disc due to such a reduction in track pitch.

That is, where the track pitch is too narrow, there may be a problem in that, when information recorded on one track is reproduced, information recorded on a track adjacent to the currently reproduced track may be included in a signal, which is currently reproduced. For this reason, the track pitch is set within a range capable of minimizing the problem.

For example, DVDs of 4.7 GB typically use a laser beam wavelength of 0.65 μm and an objective lens numerical aperture of 0.6. Under this condition, DVD-ROMs, DVD-Rs, and DVD-RWs use a standard track pitch of 0.74 μm, whereas DVD-RAMs use a standard track pitch of 0.615 μm.

FIG. 3 is a circuit diagram for explaining processing of a return beam according to a general DPP method. In the case of FIG. 3, an optical disc apparatus accesses an optical disc with information recorded in a land recording fashion or in a groove recording fashion. In this case, the optical disc has lands L and grooves G, which have approximately the same width.

In the optical disc apparatus, a laser beam emitted from a semiconductor laser is split into zero, +1st, and −1st-order diffracted beams by a grating. The zero, +1st, and −1st-order diffracted beams are irradiated onto an information recording surface of the optical disc through an objective lens. Return beams respectively corresponding to the zero, +1st, and −1st-order diffracted beams are incident to light receiving elements.

Typically, the optical system of the optical disc apparatus is configured such that, under the condition in which the spot of a main beam, that is, a zero-order diffracted beam, scans on the center of a target track to be accessed, respective beam spots of side beams, that is, −1st and +1st-order diffracted beams, scan positions spaced apart from the track center by a ½ track pitch of the optical disc 301 in outward and inward radial directions.

Hereinafter, the space between the centers of adjacent lands L or the space between the centers of adjacent grooves G is referred as a “track pitch”.

In the optical disc apparatus, reception of a return beam corresponding to the main beam is carried out by a light receiving element 302M. The light receiving element 302M has a light receiving surface divided into sections with respect to division lines extending in directions respectively corresponding to the radial and circumferential directions of the optical disc 301.

Also, reception of return beams corresponding to respective side beams is carried out by light receiving elements 302S1 and 302S2. Each of the light receiving elements 302S1 and S2 has a light receiving surface divided into sections with respect to a division line extending in a direction corresponding to the circumferential direction of the optical disc 301.

Respective output signals from the sections of the light receiving elements 302S1 and 302S2 are inputted to subtracting circuits 303 and 304, which in turn generate push-pull signals PPs1 and PPs2 (PPs1=F−E, and PPs2=H−G). Respective output signals from the sections of the light receiving element 302M are inputted to adding circuits 305 and 306, outputs of which are, in turn, applied to a subtracting circuit 307. Based on the outputs from the adding circuits 305 and 306, the subtracting circuit 307 generates a push-pull signal PPm (PPm=(A+D)−(B+C)).

The push-pull signals PPs1 and PPs2 of the side beams have a phase difference of 180° from the push-pull signal PPm of the main beam. Accordingly, when an offset is involved in the push-pull signal PPm of the main beam due to a radial shift of the objective lens or a radial inclination of the optical disc, an offset having the same phase as that of the push-pull signal PPm is involved in each of the push-pull signals PPs1 and PPs2 of the side beams.

In order to avoid generation of such an offset in the optical disc apparatus, accordingly, the push-pull signals PPs1 and PPs2 are summed by an adding circuit 308. The summed result is then amplified at a predetermined gain k. The amplified signal is then subtracted from the push-pull signal PPm of the main beam in a subtracting circuit 310. Thus, a tracking error signal TE is generated, which is expressed by “TE={(A+D)−(B+C)}−k{(F−E)+(H−G)}”.

The tracking error signal is inputted to a digital signal processor (DSP). Based on an output signal from the DSP, the objective lens is controlled to perform a tracking control operation.

Currently, DVDs are being greatly highlighted in the optical disc field, as an important element in a multimedia system. Accordingly, it is essentially required to develop an optical pickup device usable for various types of DVDs such as a DVD±R/RW, a DVD-RAM, and a DVD-ROM.

For the DVD-ROM and DVD-RAM, the DPP method using three beams is mainly used to generate a tracking error signal. However, it is difficult for the DPP method to be applied to both the media having different track pitches because the DPP method requires an accuracy in positioning side beams on opposite track edges. Furthermore, there may be a drawback in that a considerable reduction in detected tracking error values occurs when the DPP method is applied to discs having different track pitches. In this case, it may be impossible to achieve a desired servo control operation.

In other words, it is difficult for the DPP method to be applied to both the DVD-ROM and the DVD-RAM because the DVD-ROM has a track pitch of 0.74 μm, whereas the DVD-RAM has a track pitch of 0.615 μm. For this reason, optical pickup devices for multi-DVDs should be equipped with a tracking error signal detecting system applicable to diverse DVDs irrespective of the different track pitches of those DVDs.

### SUMMARY OF THE INVENTION

The present invention has been made in view of the above mentioned requirements, and an object of the invention is to provide a tracking servo control apparatus and method using a rotatable grating adapted to enable a DVD pickup device thereof to trace tracks having different track pitches.

Another object of the invention is to provide a tracking servo control apparatus and method capable of compensating for misalignment of an image focused on a photodetector thereof due to rotation of a grating thereof, thereby achieving an accurate tracking servo control operation based on a DPP method.

In accordance with one aspect, the present invention provides a tracking servo control apparatus comprising: a light source for emitting a light beam; a grating for diffracting the light beam emitted from the light source, thereby splitting the light beam into three beams; means for rotating the grating by a predetermined angle; an objective lens for converging the three beams to form spots of the three beams on a recording surface of an optical disc; optical path shifting means arranged between the light source and the objective lens, and adapted to shift respective optical paths of the three beams; a collimating lens arranged between the optical path shifting means and the objective lens, and adapted to collimate the three beams; a sectioned photodetector aligned with the optical path shifting means while being arranged in front or rear of the optical path shifting means, the photodetector including a main photodiode having four photodiode sections for receiving a main one of the three beams reflected from the optical disc via the optical path shifting means, and two sub photodiodes each having two photodiode sections for receiving an associated one of two side ones of the three reflected beams, to detect a tracking error signal, based on the received main and side beams; and tracking control means for performing a tracking control operation, based on the tracking error signal from the photodetector, determining the type of the optical disc, and controlling the rotating means when it is determined that the optical disc is a DVD-RAM, to rotate the grating by the predetermined angle.

In accordance with another aspect, the present invention provides a tracking servo control method comprising the steps of: (A) determining, by an optical pickup unit, whether an optical disc to be subjected to a reproducing or recording operation is a DVD-ROM or a DVD-RAM; (B) if it is determined at the step (A) that the optical disc is a DVD-ROM, performing a tracking servo control operation; and (C) if it is determined at the step (A) that the optical disc is a DVD-RAM, rotating a grating, and then performing the tracking servo control operation.

In accordance with another aspect, the present invention provides a tracking servo control method comprising the steps of: (A) determining, by an optical pickup unit, whether an optical disc to be subjected to a reproducing or recording operation is a DVD-ROM or a DVD-RAM; (B) if it is determined at the step (A) that the optical disc is a DVD-ROM, performing a tracking servo control operation; and (C) if it is determined at the step (A) that the optical disc is a DVD-RAM, rotating a grating adapted to split, into a main beam and sub beams, a light beam emitted from the optical pickup unit, and then performing the tracking servo control operation, using respective 1st-order diffracted beams of the side beams, which are enlarged while passing through a hologram optical element.

### BRIEF DESCRIPTION OF THE DRAWINGS

The above objects, and other features and advantages of the present invention will become more apparent after reading the following detailed description when taken in conjunction with the drawings, in which:

FIG. 1 is a block diagram illustrating a basic configuration of a general optical disc recording/reproducing apparatus adapted to record data on a general optical disc, and to reproduce the recorded data;

FIG. 2 is a schematic view illustrating a signal recording surface of a general optical disc;

FIG. 3 is a circuit diagram for explaining processing of a return beam according to a general DPP method;

FIG. 4 is a schematic view illustrating the configuration of a DVD-ROM optical system enabling data reproduction of a DVD-RAM in accordance with the present invention;

FIG. 5 is a schematic view illustrating the configuration of an 8-section photodetector included in the DVD-ROM optical system which enables data reproduction of a DVD-RAM in accordance with the present invention;

FIG. 6 is a schematic view for explaining rotation of side beams caused by rotation of a grating carried out in accordance with the type of the optical disc, that is, the DVD-ROM or DVD-RAM;

FIG. 7 is a schematic view illustrating a rotating unit for a grating shown in FIG. 4 in accordance with an embodiment of the present invention;

FIG. 8 is a schematic view illustrating a rotating unit for a grating according to another embodiment of the present invention, which has a structure different from that of FIG. 4;

FIG. 9 is a schematic view illustrating the configuration of a DVD-ROM/DVD-RAM optical system enabling data reproduction/recording of a CD-RW in accordance with the present invention;

FIG. 10 is a schematic view illustrating the configuration of an 8-section photodetector applied to the present invention;

FIG. 11 is a flow chart illustrating a tracking servo control method carried out using the tracking servo control apparatus using a rotatable grating in accordance with an embodiment of the present invention;

FIG. 12 is a schematic view illustrating an offset of sub beams generated due to rotation of the grating shown in FIG. 4;

FIG. 13 is an exploded perspective view illustrating an ultrasonic motor adapted to the grating and sub photodiodes shown in FIG. 4 in accordance with an embodiment of the present invention;

FIG. 14 is a sectional view of the ultrasonic motor shown in FIG. 13, illustrating an assembled state of the ultrasonic motor;

FIG. 15 is a sectional view illustrating respective states of protrusions and a rotor in a state in which resonance occurs;

FIG. 16 is a sectional view illustrating respective states of the protrusions and rotor in a state in which no resonance occurs;

FIG. 17 is a schematic view illustrating an ultrasonic motor adapted to rotate the grating and sub photodiodes of FIG. 4 in accordance with another embodiment of the present invention;

FIG. 18 is a schematic view for explaining a cantilever motion of the ultrasonic motor shown in FIG. 17;

FIG. 19 is a flow chart illustrating a tracking servo control method carried out using the tracking servo control apparatus using a rotatable grating in accordance with an embodiment of the present invention;

FIG. 20 is a schematic view illustrating a configuration of a tracking servo control apparatus using a rotatable grating in accordance with another embodiment of the present invention;

FIG. 21 is a schematic view illustrating a configuration of photodiodes used in the tracking servo control apparatus shown in FIG. 20; and

FIG. 22 is a flow chart illustrating a tracking servo control method carried out using the tracking servo control apparatus using a rotatable grating in accordance with the embodiment of the present invention shown in FIG. 20.

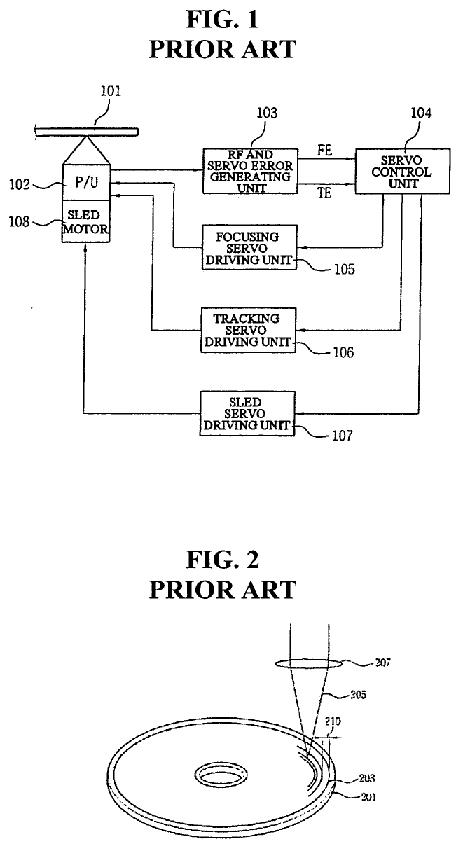

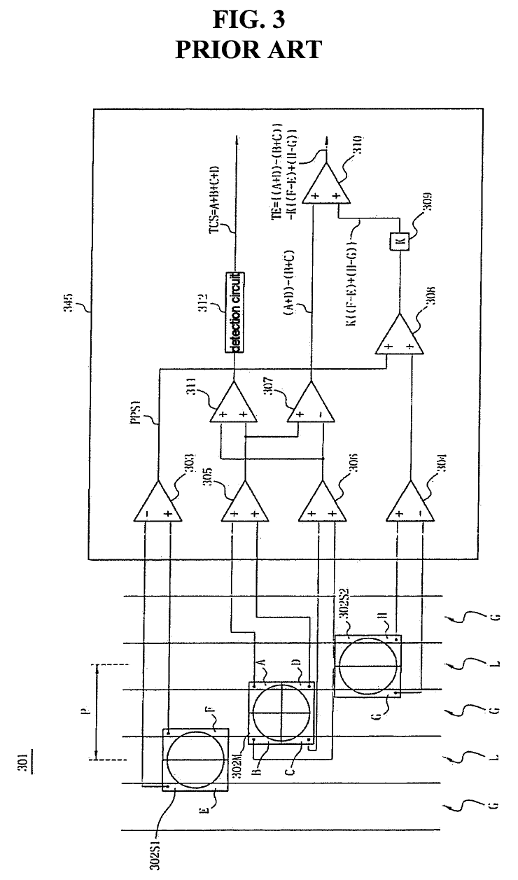

### DESCRIPTION OF THE PREFERRED EMBODIMENTS

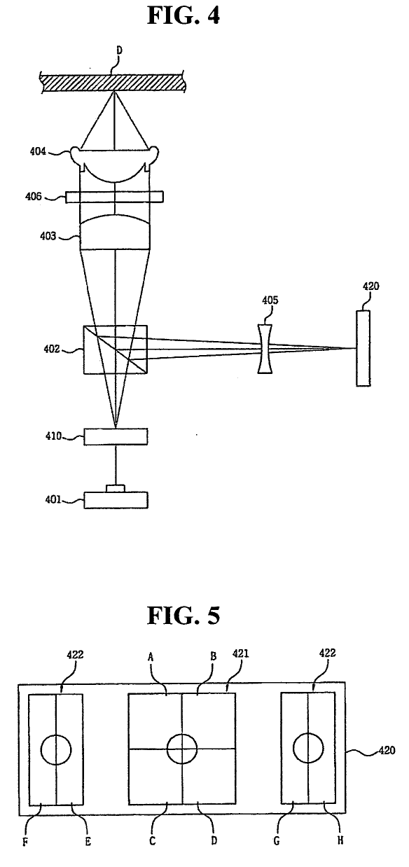

Now, a preferred embodiment of the present invention will be described with reference to FIG. 4.

FIG. 4 is a schematic view illustrating the configuration of a DVD-ROM optical system enabling data reproduction of a DVD-RAM in accordance with the present invention. FIG. 5 is a schematic view illustrating the configuration of an 8-section photodetector included in the DVD-ROM optical system which enables data reproduction of a DVD-RAM in accordance with the present invention.

Referring to FIG. 4, the DVD-ROM optical system includes a light source 401 adapted to emit a divergent laser beam having a wavelength of 650 nm, and a beam splitter 402 adapted to transmit the divergent laser beam emitted from the light source 401 while reflecting a laser beam reflected from the recording surface of an optical disc D.

The divergent laser beam transmitted through the beam splitter 402 is irradiated onto a collimating lens 403 which, in turn, converts the laser beam into a parallel beam. The parallel beam emerging from the collimating lens 403 is irradiated onto the optical disc D in a focused state by an objective lens 404. For execution of a focusing servo operation, the laser beam reflected from the optical disc D is converted in accordance with an astigmatism method by a condenser/cylindrical lens 405.

A grating 410 is arranged between the light source 401 and the beam splitter 402 to split the laser beam emitted from the light source 401 into three beams, that is, one main beam and two side beams, so that the DVD-ROM optical system is usable for data reproduction of both the DVD-ROM and the DVD-RAM. When it is desired to perform data reproduction of the optical disc D, the DVD-ROM optical system, which is configured to enable data reproduction of a DVD-RAM, determines whether the optical disc D is a DVD-RAM or a DVD-ROM. Where the optical disc D is a DVD-RAM, the grating 410 is rotated by a predetermined angle to vary the radial distance of each side beam from the main beam such that it is possible to detect a tracking error signal generated in association with the DVD-RAM.

Meanwhile, an 8-section photodetector 420 is arranged downstream from the condenser/cylindrical lens 405. The 8-section photodetector 420 includes a main photodiode 421 having four sections A, B, C and D, and a pair of sub photodiodes 422 each having two sections E and F or G and H, as shown in FIG. 5.

For data reproduction of a DVD-ROM, the main photodiode 421, which has four sections A, B, C, and D, performs focusing and tracking servo operations by detecting a read signal and error signals (focusing and tracking error signals) from main and side beams reflected from the recording surface of the DVD-ROM in accordance with the above described DPP method and astigmatism method. For data reproduction of a DVD-RAM, the main photodiode 421 detects a read signal and error signals from main and side beams reflected from the recording surface of the DVD-RAM in accordance with the DPP method.

That is, the main photodiode 421 detects the read signal and focusing error signal, whereas the sub photodiodes 422, each of which has sections E and F or G and H, detect the read signal and tracking error signal.

Now, the operation of the optical system compatible with both the DVD-ROM and the DVD-RAM in accordance with the present invention will be described in detail with reference to FIGS. 4 and 5.

When a divergent laser beam having a wavelength of 650 nm is emitted from the light source 401, it is split into three beams by the grating 410. The three beams emerging from the grating 410 are incident to the beam splitter 402. After passing through the beam splitter 402, the three beams are converted into parallel beams by the collimating lens 403.

The three beams, which are converted into parallel beams by the collimating lens 403, are incident to the objective lens 404 after passing through a phase shift plate 406 having a phase shift of, for example, λ/4. The objective lens 404 irradiates the incident beams onto the recording surface of the optical disc D in a focused state.

After being reflected from the recording surface of the optical disc D, the three beams pass through the objective lens 404, phase shift plate 406, and collimating lens 403, and then reach the beam splitter 402. After being reflected from the beam splitter 402, the three beams pass through the condenser/cylindrical lens 405, and then reach the 8-section photodetector 420. Thus, the main beam is incident to the main photodiode 421 having four sections A, B, C, and D, whereas the side beams are incident to one side photodiode 422 having two sections E and F and the other side photodiode 422 having two sections G and H, respectively.

When the optical system recognizes the optical disc D to be a DVD-ROM, the 8-section photodetector 420 generates a read signal, a focusing error signal and a tracking error signal in accordance with the DPP method and astigmatism method, based on the three beams, that is, the main and side beams, incident thereto after being reflected from the recording surface of the DVD-ROM and passing through the beam splitter 402 and condenser/cylindrical lens 405.

On the other hand, when the optical system recognizes the optical disc D to be a DVD-RAM, the grating 410 is rotated by a predetermined angle. In this state, the 8-section photodetector 420 generates a read signal, a focusing error signal and a tracking error signal through the main photodiode 421 and sub photodiodes 422 in accordance with the DPP method, based on the three beams, that is, the main and side beams, incident thereto after being reflected from the recording surface of the DVD-ROM and passing through the beam splitter 402 and condenser/cylindrical lens 405.

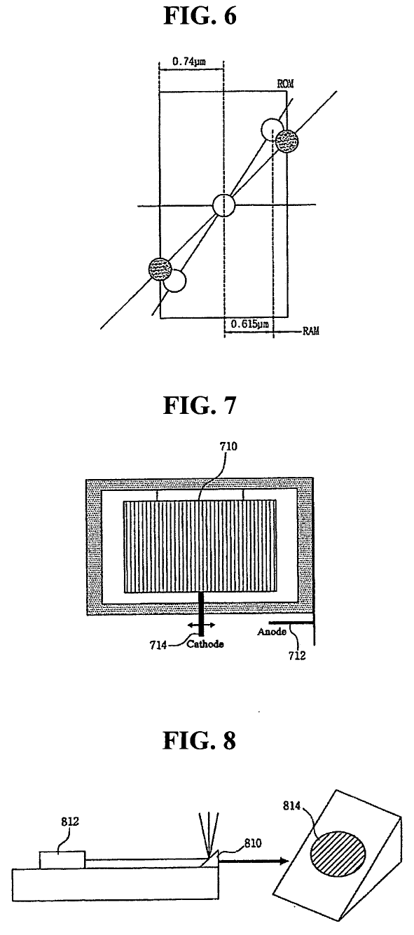

FIG. 6 is a schematic view for explaining rotation of the side beams caused by rotation of the grating carried out in accordance with the type of the optical disc, that is, the DVD-ROM or DVD-RAM.

Referring to FIG. 6, in the case of a DVD-ROM, its track pitch is 0.74 μm. In this case, accordingly, the distance between the main beam and each side beam is 20 μm. Where it is assumed that “θ” is an angle defined between a track, at which the spot of the main beam is positioned, and a straight line extending through the main and side beams, the angle θ is about 87.88° because cos θ=0.74/20=0.037.

On the other hand, in the case of a DVD-RAM, its track pitch is 0.615 μm. In this case, accordingly, the angle θ is about 88.24° because cos θ=0.615/20=0.0307. Thus, the rotation range of the grating 410 is 87.88° to 88.24°.

FIG. 7 is a schematic view illustrating a rotating unit for the grating shown in FIG. 4 in accordance with an embodiment of the present invention.

Referring to FIG. 7, the rotating unit includes an anode 712 to be used as an electromagnet, and a cathode 714. The rotating unit can control the rotating angle of a grating 710 by controlling the amount of current supplied to the anode 712. Thus, the rotating unit can rotate the grating 710 by use of such a mechanical mechanism.

FIG. 8 is a schematic view illustrating a rotating unit for a grating according to another embodiment of the present invention, which has a structure different from that of FIG. 4.

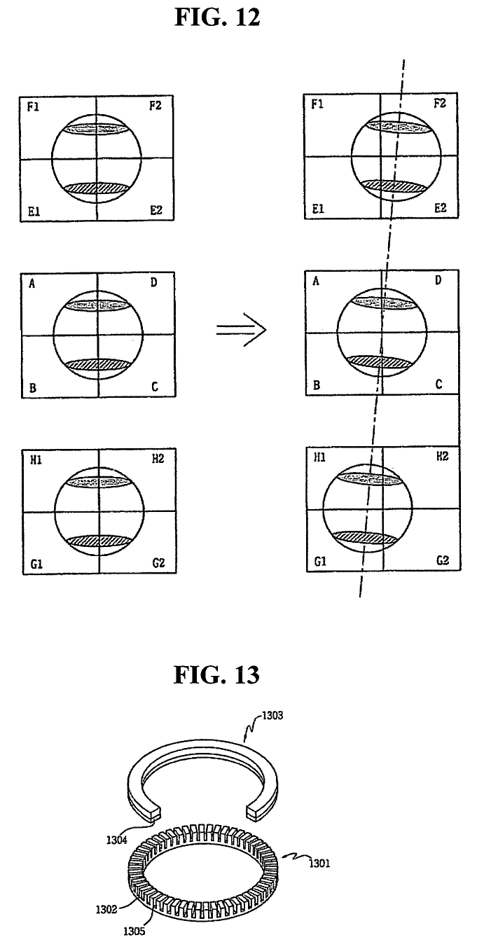

Referring to FIG. 8, a reflective grating 814 is mounted to a hologram module 810. The reflective grating 814 substitutes for an LD mirror, which is conventionally mounted to the hologram module 810. The reflective grating 814 is rotated by a micro electro mechanical system (MEMS) element. An ultrasonic motor, which is an example of the MEMS element, is illustrated in FIG. 13.

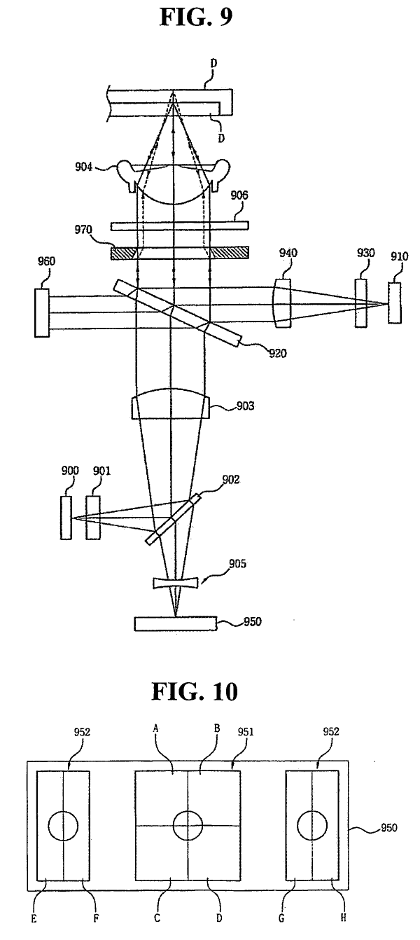

FIG. 9 is a schematic view illustrating the configuration of a DVD-ROM/DVD-RAM optical system enabling data reproduction/recording of a CD-RW in accordance with the present invention. FIG. 10 is a schematic view illustrating the configuration of an 8-section photodetector applied to the present invention.

Referring to FIG. 9, the DVD-ROM/DVD-RAM optical system includes a laser diode 900 for DVDs adapted to emit a laser beam having a wavelength of 650 nm so as to enable data reproduction of an optical disc D, which is a DVD-ROM or DVD-RAM.

The laser beam emitted from the laser diode 900 is split into three beams by a grating 901, and is then incident to a beam splitter 902. At this time, the DVD-ROM optical system, which is configured to enable data reproduction of a DVD-RAM, determines whether the optical disc D is a DVD-RAM or a DVD-ROM. Where the optical disc D is a DVD-RAM, the grating 901 is rotated by a predetermined angle to vary the radial distance of each side beam from the main beam such that it is possible to detect a tracking error signal generated in association with the DVD-RAM.

The beam splitter 902 reflects the three divergent laser beams emerging from the grating 901, while transmitting beams reflected from the recording surface of the optical disc D, that is, the DVD-ROM or DVD-RAM. The three divergent laser beams are then incident to a collimating lens 903 for DVDs, which in turn converts the laser beams into parallel beams.

The parallel laser beams emerging from the collimating lens 903 are irradiated onto the optical disc D, that is, the DVD-ROM or DVD-RAM, in a focused state by an objective lens 904. For execution of a focusing servo operation, the laser beams reflected from the optical disc D, that is, the DVD-ROM or DVD-RAM, are converted in accordance with an astigmatism method by a condenser/cylindrical lens 905.

On the other hand, the CD-RW optical system includes a laser diode 910 for CDs adapted to emit a laser beam having a wavelength of 780 nm to enable data recording and reproduction of an optical disc D′, which is a CD-RW.

A plate beam splitter 920 is arranged at a position where the laser beam of 780 nm emitted from the laser diode 910 for CDs and the laser beam of 650 nm emitted from the laser diode 900 for DVDs cross, in a state of being inclined toward the laser diode 910 for CDs, that is, in a clockwise direction in FIG. 9, by 45°. The plate beam splitter 920 reflects the laser beam of 780 nm toward the objective lens 904 while transmitting the laser beam of 780 nm to a monitoring photodetector 960. The plate beam splitter 920 also transmits the laser beam of 650 nm and the reflected beams of 650 nm and 780 nm.

The plate beam splitter 920 has a thickness of 1.5 mm or less in order to minimize the aberration generated during the transmission of laser beams therethrough. Since the plate beam splitter is arranged in a state of being inclined by an angle of 45°, the laser beam of 650 nm emitted from the laser diode 900 for DVDs can be accurately incident to the objective lens 904 in so far as the laser beam is incident to the plate beam splitter 920 in the form of a parallel beam. For this reason, the plate beam splitter 920 is arranged downstream from the collimating lens 903 to receive a parallel beam.

A grating 930 is arranged between the laser diode 910 for CDs and the plate beam splitter 920 in order to split the laser beam of 780 nm into three beams for data recording and reproduction of the optical disc D′, that is, the CD-RW.

A collimating lens 940 for CDs is arranged between the plate beam splitter 920 and the grating 930 in order to collimate the laser beam of 780 nm emitted from the laser diode 910 for CDs.

Meanwhile, the 8-section photodetector 950, which is usable for both the DVD-ROM/DVD-RAM optical system and the CD-RW optical system, is arranged on an optical path of reflected beams, in order to detect a read signal and error signals of the optical disc D, that is, the DVD-ROM or DVD-RAM, and a write/read signal and error signals of the optical disc D′, that is, the CD-RW, using reflected beams incident thereto after being reflected from respective recording surfaces of the optical discs D and D′, that is, the DVD-ROM or DVD-RAM and the CD-RW, and passing through the objective lens 904, plate beam splitter 920 and collimating lens 903 for DVDs.

As shown in FIG. 10, the 8-section photodetector 950 includes a main photodiode 951 having four sections A, B, C and D, and a pair of sub photodiodes 952 each having two sections E and F or G and H.

For data reproduction of the optical disc D, that is, the DVD-ROM or DVD-RAM, the main photodiode 951 and sub photodiodes 952 perform focusing and tracking servo operations by detecting a read signal and error signals (focusing and tracking error signals) from main and side beams reflected from the recording surface of the optical disc D, that is, the DVD-ROM or DVD-RAM in accordance with the DPP method and astigmatism method. For data recording of the optical disc D′, that is, the CD-RW, the main photodiode 951 and sub photodiodes 952 detect a write signal and error signals from main and side beams reflected from the recording surface of the optical disc D′, that is, the CD-RW, in accordance with the DPP method and astigmatism method. For data reproduction of the optical disc D′, that is, the CD-RW, the main photodiode 951 and sub photodiodes 952 detect a read signal and error signals from main and side beams reflected from the recording surface of the optical disc D′, that is, the CD-RW, in accordance with the DPP method and astigmatism method.

The reason why the PP method uses the 8-section photodiode for data reproduction/recording of the CD-RW, in place of a 6-section photodiode, is that the 8-section photodiode can prevent a tracking offset from being generated due to a tilt of the disc, a light distribution difference caused by a shift of the objective lens, or a reflectance difference of side beams caused when the spots of the side beams are positioned at a recorded region and an unrecorded region, respectively.

The monitoring photodetector 960 is arranged on an optical path of the laser beam of 780 nm at one side of the plate beam splitter 920 in order to control the intensity of the laser beam of 780 nm, based on the laser beam incident thereto after passing through the plate beam splitter 920.

A variable iris 970 is arranged between the objective lens 904 and the plate beam splitter 920 in order to adjust the diameter of the laser beam of 650 nm or 780 nm incident to the objective lens 904. A hologram element may be used to adjust the diameter of the laser beam incident to the objective lens 904.

Now, the operation of the DVD-ROM/DVD-RAM optical system configured to enable data reproduction/recording of a CD-RW in accordance with the present invention will be described in detail with reference to FIG. 9.

When a laser beam having a wavelength of 650 nm is emitted from the laser diode 900 for DVDs for data reproduction of the optical disc D, that is, the DVD-ROM or DVD-RAM, it is split into three beams by the grating 901. The three beams emerging from the grating 901 are reflected toward the collimating lens 903 for DVDs by the beam splitter 902. At this time, the DVD-ROM optical system, which is configured to enable data reproduction of a DVD-RAM, determines whether the optical disc D is a DVD-RAM or a DVD-ROM. Where the optical disc D is a DVD-RAM, the grating 901 is rotated by a predetermined angle to vary the radial distance of each side beam from the main beam such that it is possible to detect a tracking error signal generated in association with the DVD-RAM.

The laser beams of 650 nm incident to the collimating lens 903 for DVDs are converted into parallel beams by the collimating lens 903, and are then incident to the objective lens 904 after passing through the plate beam splitter 920.

At this time, the variable iris 970 adjusts the diameter of the 650 nm laser beam such that the numerical aperture of the objective lens 904 corresponds to a numerical aperture of 0.6 for the DVD-ROM/DVD-RAM.

The parallel laser beams emerging from the collimating lens 903 are irradiated onto the optical disc D, that is, the DVD-ROM or DVD-RAM, in a focused state by the objective lens 904, and then reflected from the optical disc D. The reflected beams are converged into the condenser/cylindrical lens 905 after sequentially passing through the objective lens 904, variable iris 970, plate beam splitter 920, collimating lens 903 for DVDs, and beam splitter 902.

The condenser/cylindrical lens 905 astigmatizes the reflected beams, so as to allow the 8-section photodetector 950 to generate a read signal and focusing and tracking error signals in accordance with the DPP method and astigmatism method.

Thus, the 8-section photodetector 950 can reproduce data recorded on the recording surface of the optical disc D, that is, the DVD-ROM or DVD-RAM.

On the other hand, upon recording or reproducing the optical disc D′, that is, the CD-RW, the variable iris 970 adjusts the diameter of the 780 nm laser beam such that the numerical aperture of the objective lens 904 corresponds to a numerical aperture of 0.5 for the CD-RW.

When a laser beam having a certain intensity at a wavelength of 780 nm is emitted from the laser diode 910 for CDs under this condition, it is split into three beams by the grating 930. The three beams are then incident to the collimating lens 940 for CDs.

The collimating lens 940 converts the incident divergent beams into parallel beams, which is, in turn, incident to the plate beam splitter 920.

The three parallel beams incident to the plate beam splitter 920 is reflected toward the objective lens 920 while being transmitted to the monitoring photodetector 960, by the plate beam splitter 920. Thus, the monitoring photodetector 960 detects the intensity of the laser beams incident thereto, thereby controlling the intensity of the laser beam emitted from the laser diode 910.

The laser beams of 780 nm incident to the objective lens 904 via the variable iris 970 after being reflected from the plate beam splitter 920 are irradiated onto the recording surface of the optical disc D′, that is, the CD-RW, and then reflected from the optical disc D′. The reflected beams are converged into the condenser/cylindrical lens 905 after sequentially passing through the objective lens 904, variable iris 970, plate beam splitter 920, collimating lens 903 for DVDs, and beam splitter 902.

The condenser/cylindrical lens 905 astigmatizes the reflected beams, so as to allow the 8-section photodetector 950 to generate a read signal and focusing and tracking error signals in accordance with the DPP method and astigmatism method or to generate a write signal and focusing and tracking error signals in accordance with the DPP method and astigmatism method.

Thus, for data recording of the optical disc D′, that is, the CD-RW, the 8-section photodetector 950 generates a write signal, and focusing and tracking error signals in accordance with the DPP method and astigmatism method, in order to form a pit on the recording surface of the optical disc D′, that is, the CD-RW. On the other hand, for data reproduction of the optical disc D′, that is, the CD-RW, the 8-section photodetector 950 generates a read signal, and focusing and tracking error signals in accordance with the DPP method and astigmatism method, in order to reproduce data recorded on the recording surface of the optical disc D′, that is, the CD-RW.

Thus, the present invention provides a compatible optical system which is usable for both the DVD-ROM/DVD-RAM and the CD-RW. Since the optical system uses an inexpensive plate beam splitter, in place of an expensive beam splitter having a cubic structure, its manufacturing costs can be reduced.

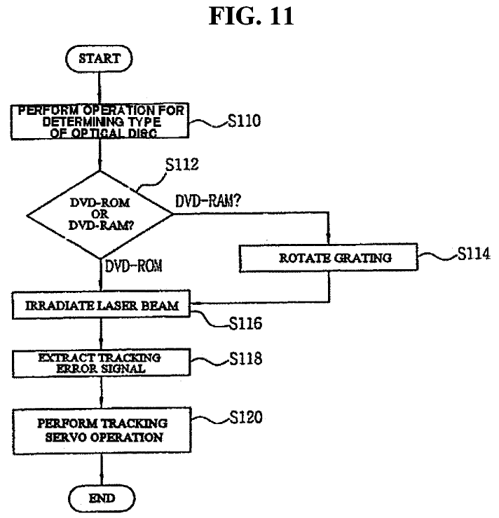

FIG. 11 is a flow chart illustrating a tracking servo control method carried out using the tracking servo control apparatus using a rotatable grating in accordance with an embodiment of the present invention.

In accordance with the tracking servo control method, the optical pickup unit included in the tracking servo control apparatus performs an operation for determining the type of an optical disc loaded in the apparatus (Step S110). Thereafter, it is determined whether the optical disc is a DVD-ROM or a DVD-RAM (Step S112). When it is determined that the optical disc is a DVD-RAM, the rotating grating is rotated by a predetermined angle (Step S114).

A laser beam is subsequently irradiated onto the optical disc (Step S116). A tracking error signal is then extracted (Step S118). Based on the tracking error signal, a tracking servo operation is carried out (Step S120).

Meanwhile, the above described “tracking servo control apparatus and method using a rotatable grating” may involve a problem in that the centers of side beams may be slightly misaligned from the photodiodes associated therewith in accordance with rotation of the grating, respectively, as shown in FIG. 12, so that a degradation in accuracy may occur.

When the grating rotates, the side beams are not shifted in the horizontal direction, but rather are shifted in a circumferential direction, as shown in FIG. 12. That is, the side beams are rotated by a certain angle. Where it is assumed that the size of a beam spot on the photodetector is 100 μm, and the distance between the main beam and each side beam is 200 μm, the grating is rotated through an angle of 7°. In accordance with this rotation, a horizontal shift of about 2 μm occurs, even though there is little or no shift in the vertical direction.

In this case, the tracking error signal TE detected in accordance with the DPP method may be expressed by the following Expression 1:
TE={(A+D)−(B+C)}−k{(F−E)+(H−G)} [Expression 1]

where, “A”, “B”, “C”, and “D” represent signals detected by the sections A, B, C and D of the main photodiode 951, respectively, and “E”, “F”, “G”, and “H” represent signals detected by the sections E, F, G and H of the sub photodiodes 952, respectively. Also, “k” represents a gain for amplification.

Referring to Expression 1, it can be seen that signals F1, F2, H1, and H2 respectively detected by the photodiode sections F1, F2, H1, and H2 in FIG. 12 have the same sign, and signals E1, E2, G1, and G2 respectively detected by the photodiode sections E1, E2, G1, and G2 in FIG. 12 have the same sign.

Although there may be a variation in the signals detected by the photodiode sections due to the rotation of the grating, the same variation is exhibited in association with both side beams. Accordingly, it is possible to eliminate such a variation caused by the rotation of the grating in association with the signals F1, F2, H1, and H2 by summing the signals F1, F2, H1, and H2. Also, it is possible to eliminate the variation associated with the signals E1, E2, G1, and G2 by summing the signals E1, E2, G1, and G2. Thus, there is no influence of the grating rotation on the tracking error signal TE. However, there may still be an offset caused by asymmetrical variations associated with the two side beams because the side beams have different shapes.

In order to solve such a problem, the present invention also provides a tracking servo control apparatus and method capable of compensating for misalignment of an image focused on the photodetector due to rotation of the grating, thereby achieving an accurate tracking servo control operation based on a DPP method.

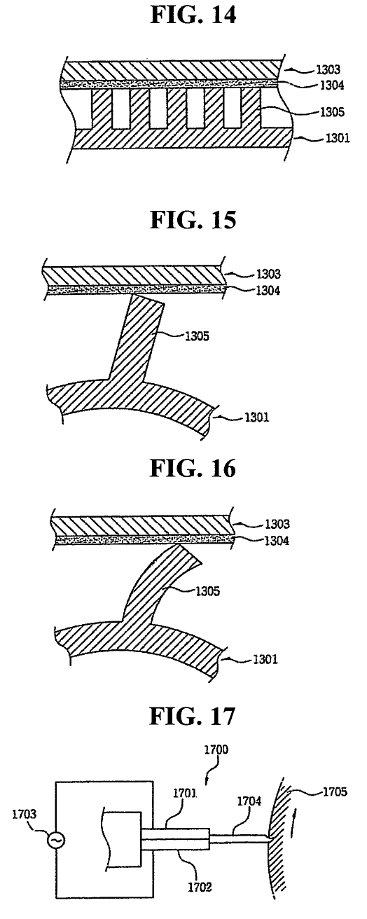

FIG. 13 is an exploded perspective view illustrating an ultrasonic motor adapted to the grating and sub photodiodes shown in FIG. 4 in accordance with an embodiment of the present invention. FIG. 14 is a sectional view of the ultrasonic motor shown in FIG. 13, illustrating an assembled state of the ultrasonic motor. FIG. 15 is a sectional view illustrating respective states of protrusions and a rotor in a state in which resonance occurs. FIG. 16 is a sectional view illustrating respective states of the protrusions and rotor in a state in which no resonance occurs.

As shown in FIGS. 13 to 16, the ultrasonic motor, which is adapted to rotate the grating and sub photodiodes shown in FIG. 4, includes a stator 1301 having an annular structure, and a rotor 1303 having an annular structure. The stator 1301 includes a piezoelectric substrate 1302 composed of piezoelectric ceramic elements, and protrusions 1305 provided on the piezoelectric substrate 1302 while being circumferentially spaced apart from one another to form a protrusion/groove structure. A frictional pad 1304 is attached to the rotor 1303.

The driving principle of the ultrasonic motor having the above described configuration will now be described. When an AC voltage is applied across the piezoelectric substrate 1302 arranged at a lower end of the stator 1301, vertical vibrations are generated in accordance with a repeated variation in the polarity of the applied AC voltage. Such vibrations are called “standing wave motions”.

Meanwhile, when the application of the AC voltage is carried out in such a manner that voltages, which have the same level while having different phases, are applied to adjacent ones of the piezoelectric ceramic elements composing the piezoelectric substrate 1302, a traveling wave motion is generated. That is, the vertical vibrations are changed into an ellipsoidal motion involving a circumferential motion, that is, rotation.

As a result, there is a phenomenon that the protrusions 1305 of the stator 1301 tend to travel circumferentially while pushing the frictional pad 1304 of the rotor 1303 at upper ends thereof. However, since the stator 1301 is in a fixed state, the rotor 1303, which is in close contact with the upper surface of the stator 1301, is subjected to a rotating force exerted in a direction opposite to the direction of the traveling wave motion.

It is possible to increase the number of revolutions of the rotor 1303 by increasing the frequency of bending vibrations generated at the stator 1301. In this case, it is also possible to avoid attenuation of the bending vibrations, using a certain pressure P. The motion force of the entire vibration system can be enhanced, as long as a reliable operation of the ultrasonic motor is secured.

The protrusions 1305 serve as a ¼λ resonator adapted to generate bending vibrations. The number of the protrusions 1305 is set such that the weight of the half-wavelength portion of the stator 1301 is not less than the total weight of the protrusions 1305.

In the operation of the ultrasonic motor having the above described configuration, pure vertical mechanical resonance generated at the piezoelectric substrate 1302 is converted into ellipsoidal mechanical resonance due to the two different phases of the piezoelectric substrate 1302.

The protrusions 1305, which have a distribution of curved waves, serve as a support for driving the rotor 1303. The protrusions 1305 are in contact with the rotor 1303 at their upper ends, so that they can rotate the rotor 1303.

As shown in FIG. 14, the protrusions 1305 operate as a resonator for generating bending vibrations corresponding to the resonant frequency of an annular structure when they resonate. When the protrusions 1305 do not resonate, they are bent by a certain distance such that they are positioned beyond resonant points, respectively, as shown in FIG. 15.

When the protrusions 1305 are in contact with the rotor 1303 in a bent state, the level of vibrations at the upper ends of the protrusions 1305 is increased, so that the mechanical motion of the rotor 1303 is changed in accordance with frictional interactions between the rotor 1303 and the frictional pad 1304.

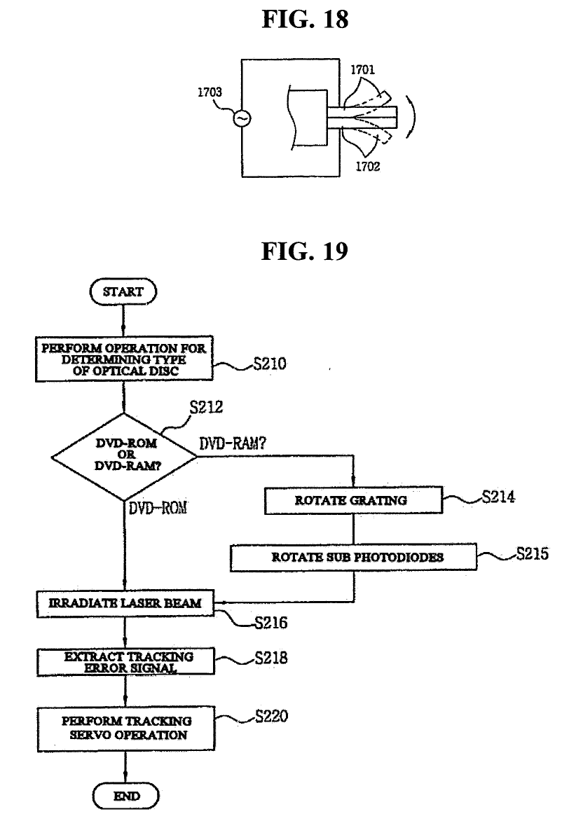

FIG. 17 is a schematic view illustrating an ultrasonic motor adapted to rotate the grating and sub photodiodes of FIG. 4 in accordance with another embodiment of the present invention. FIG. 18 is a schematic view for explaining a cantilever motion of the ultrasonic motor shown in FIG. 17. As shown in FIGS. 17 and 18, the ultrasonic motor includes a piezoelectric vibrator 1700 having a bimetal structure. That is, the piezoelectric vibrator 1700 includes a piezoelectric member 1701 whose length varies when a voltage is applied thereto, and a non-elongation member 1702 exhibiting little or no variation in length when a voltage is applied thereto. The ultrasonic motor also includes an actuating member 1704 attached to a free end of the piezoelectric vibrator 1700.

The piezoelectric member 1701 and non-elongation member 1702 are bonded to each other. Accordingly, when a voltage from a voltage source 1703 is applied across the piezoelectric vibrator 1700, the piezoelectric member 1701 tends to elongate or shrink. At this time, however, the non-elongation member 1702 does not vary in length. As a result, cantilever vibrations are generated at the piezoelectric vibrator 1700.

Accordingly, the actuating member 1704 pushes teeth of a gear 1705 provided at a holder fitted around the grating, thereby rotating the grating.

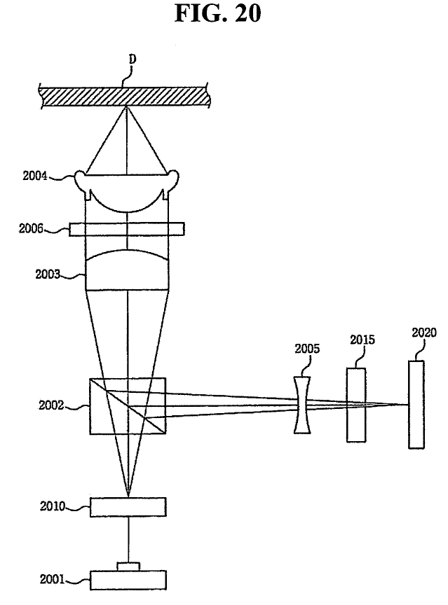

FIG. 19 is a flow chart illustrating a tracking servo control method carried out using the tracking servo control apparatus using a rotatable grating in accordance with an embodiment of the present invention.

In accordance with the tracking servo control method, the optical pickup unit included in the tracking servo control apparatus performs an operation for determining the type of an optical disc loaded in the apparatus (Step S210). Thereafter, it is determined whether the optical disc is a DVD-ROM or a DVD-RAM (Step S212). When it is determined that the optical disc is a DVD-RAM, the rotating grating is rotated by a predetermined angle (Step S214).

A laser beam is subsequently irradiated onto the optical disc (Step S216). A tracking error signal is then extracted (Step S218). Based on the tracking error signal, a tracking servo operation is carried out (Step S220). At this time, rotation of the sub photodiodes may also be carried out to compensate for possible misalignment of an image focused on the photodetector due to rotation of the grating (Step S215).

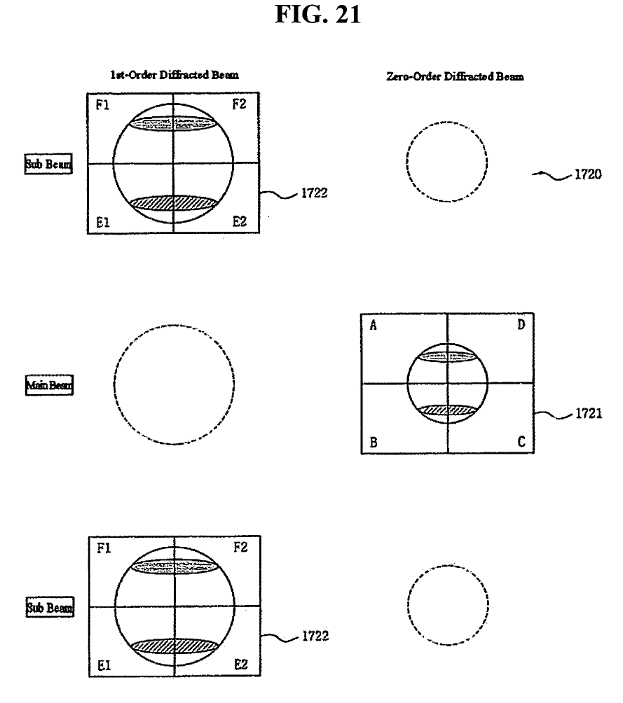

FIG. 20 is a schematic view illustrating a configuration of a tracking servo control apparatus using a rotatable grating in accordance with another embodiment of the present invention. FIG. 21 is a schematic view illustrating a configuration of photodiodes used in the tracking servo control apparatus shown in FIG. 20.

Referring to FIG. 20, the optical system of the tracking servo control apparatus includes a light source 2001 adapted to emit a divergent laser beam having a wavelength of 650 nm, and a beam splitter 2002 adapted to transmit the divergent laser beam emitted from the light source 2001 while reflecting a laser beam reflected from the recording surface of an optical disc D.

The divergent laser beam transmitted through the beam splitter 2002 is irradiated onto a collimating lens 2003, which in turn converts the laser beam into a parallel beam. The parallel beam emerging from the collimating lens 2003 is irradiated onto the optical disc D in a focused state by an objective lens 2004. For execution of a focusing servo operation, the laser beam reflected from the optical disc D is converted in accordance with an astigmatism method by a condenser/cylindrical lens 2005.

A grating 2010 is arranged between the light source 2001 and the beam splitter 2002 to split the laser beam emitted from the light source 2001 into three beams, that is, one main beam and two side beams, so that the DVD-ROM optical system is usable for data reproduction of both the DVD-ROM and the DVD-RAM. When it is desired to perform data reproduction of the optical disc D, the DVD-ROM optical system, which is configured to enable data reproduction of a DVD-RAM, determines whether the optical disc D is a DVD-RAM or a DVD-ROM. Where the optical disc D is a DVD-RAM, the grating 2010 is rotated by a predetermined angle to vary the radial distance of each side beam from the main beam such that it is possible to detect a tracking error signal generated in association with the DVD-RAM. In this case, the rotation of the grating 2010 may be carried out, using a rotating unit, which employs an ultrasonic motor.

Meanwhile, an 8-section photodetector 2020 is arranged downstream from the condenser/cylindrical lens 2005. Also, a hologram optical element 2015 is arranged upstream from the 8-section photodetector 2020. The hologram optical element 2015 diffracts the main beam and side beams, thereby producing zero-order and 1st-order beams.

The 8-section photodetector 2020 includes a main photodiode 2021 having four sections A, B, C and D, and a pair of sub photodiodes 2022 each having four sections E1, E2, F1, and F2, as shown in FIG. 21.

For data reproduction of a DVD-ROM, the 8-section photodetector 2020 performs focusing and tracking servo operations by detecting a read signal and error signals (focusing and tracking error signals) from main and side beams reflected from the recording surface of the DVD-ROM in accordance with the above described DPP method and astigmatism method. For data reproduction of a DVD-RAM, the 8-section photodetector 2020 detects a read signal and error signals (focusing and tracking error signals) from main and side beams reflected from the recording surface of the DVD-RAM in accordance with the DPP method.

In this case, the main photodiode 2021, which is divided into the sections A, B, C and D, detects a tracking error signal, based on a zero-order diffracted beam produced in accordance with diffraction of the main beam passing through the hologram optical element 2015. On the other hand, each sub photodiode 2022, which is divided into the sections E1, E2, F1 and F2, detects a tracking error signal, based on a 1st-order diffracted beam produced in accordance with diffraction of the associated side beam passing through the hologram optical element 2015.

Now, the operation of the optical system compatible with both the DVD-ROM and the DVD-RAM in accordance with the present invention will be described in detail with reference to FIGS. 20 and 21.

When a divergent laser beam having a wavelength of 650 nm is emitted from the light source 2001, it is split into three beams by the grating 2010. The three beams emerging from the grating 2010 are incident to the beam splitter 2002. After passing through the beam splitter 2002, the three beams are converted into parallel beams by the collimating lens 2003.

The three beams, which are converted into parallel beams by the collimating lens 2003, are incident to the objective lens 2004 after passing through a phase shift plate 2006. The objective lens 2004 irradiates the incident beams onto the recording surface of the optical disc D in a focused state.

After being reflected from the recording surface of the optical disc D, the three beams pass through the objective lens 2004, phase shift plate 2006, and collimating lens 2003, and then reach the beam splitter 2002. After being reflected from the beam splitter 2002, the three beams pass through the condenser/cylindrical lens 2005, and then reach the hologram optical element 2015.

The hologram optical element 2015 produces a zero-order diffracted beam from the main beam, and 1st-order diffracted beams from respective side beams. Thus, the main photodiode 2021, which is divided into the sections A, B, C and D, uses the zero-order diffracted beam component of the main beam emerging from the hologram optical element 2015, whereas each side photodiode 2022, which is divided into the sections E1, E2, F1 and F2, uses the 1st-order diffracted beam component of the associated sub beam emerging from the hologram optical element 2015. As a result, the 1st-order diffracted beam component of the side beam, which is incident to the associated sub photodiode 2022, is focused in rear of the sub photodiode 2022 because it is enlarged, as compared to the zero-order diffracted beam component. Accordingly, it is possible to reduce an offset caused by asymmetrical variations associated with the two side beams because the side beams have different shapes.

When the optical system recognizes the optical disc D to be a DVD-ROM, the 8-section photodetector 2020 generates a read signal, a focusing error signal and a tracking error signal in accordance with the DPP method and astigmatism method, based on the three beams, that is, the main and side beams, incident thereto after being reflected from the recording surface of the DVD-ROM and passing through the beam splitter 2002, condenser/cylindrical lens 2005, and hologram optical element 2015.

On the other hand, when the optical system recognizes the optical disc D to be a DVD-RAM, the grating 2010 is rotated by a predetermined angle. In this state, the 8-section photodetector 2020 generates a read signal, a focusing error signal and a tracking error signal through the main photodiode 2021 and sub photodiodes 2022 in accordance with the DPP method, based on the three beams, that is, the main and side beams, incident thereto after being reflected from the recording surface of the DVD-ROM and passing through the beam splitter 2002, condenser/cylindrical lens 2005, and hologram optical element 2015.

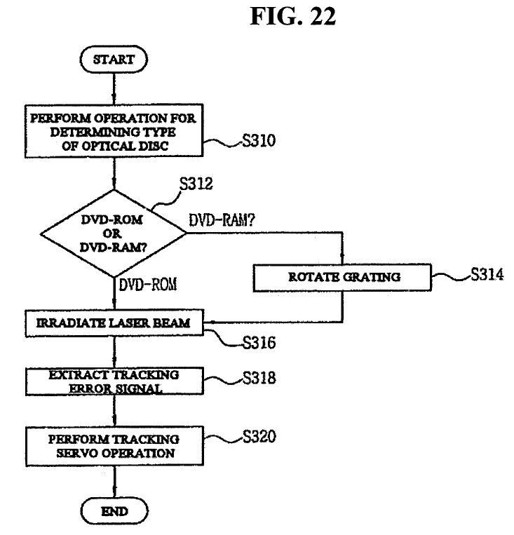

FIG. 22 is a flow chart illustrating a tracking servo control method carried out using the tracking servo control apparatus using a rotatable grating in accordance with the embodiment of the present invention shown in FIGS. 20 and 21.

In accordance with the tracking servo control method, the optical pickup unit included in the tracking servo control apparatus performs an operation for determining the type of an optical disc loaded in the apparatus (Step S310). Thereafter, it is determined whether the optical disc is a DVD-ROM or a DVD-RAM (Step S312). When it is determined that the optical disc is a DVD-RAM, the rotating grating is rotated by a predetermined angle (Step S314).

A laser beam is subsequently irradiated onto the optical disc (Step S316). A tracking error signal is then extracted (Step S318). For the extraction of the tracking error signal, the main photodiode uses a zero-order diffracted beam emerging from the hologram optical element, and each sub photodiode uses a 1st-order diffracted beam emerging from the hologram optical element. Based on the tracking error signal, a tracking servo operation is carried out (Step S320).

Although the preferred embodiments of the invention have been disclosed for illustrative purposes in association with a tracking servo control apparatus and method, those skilled in the art will appreciate that various modifications, additions and substitutions are possible, without departing from the scope and spirit of the invention as disclosed in the accompanying claims.

As apparent from the above description, a rotatable grating is used in accordance with the present invention. When the grating is rotated with respect to an optical axis, respective spots of side beams produced by the grating are rotated with respect to the optical axis, that is, a main beam, so that the radial distance between the main beam and each side beam varies. Thus, it is possible to detect a tracking error signal irrespective of the track pitch by adjusting the distance between the main beam and each side beam through a rotation of the grating by an appropriate angle.

In accordance with the present invention, an ultrasonic motor may be used to rotate the grating for a tracking servo control operation for optical discs having different track pitches. In this case, it is unnecessary to always apply a voltage to the ultrasonic motor, and thus, a reduction in power consumption is achieved. It is also possible to obtain an accurate rotating angle.

It is also possible to compensate for an offset caused by asymmetrical shapes of side beams caused by rotation of the grating, and thus, to achieve an accurate tracking servo control operation.

1. A tracking servo control apparatus comprising:
a light source for emitting a light beam;
a grating for diffracting the light beam emitted from the light source, thereby splitting the light beam into three beams;
a first rotating unit for rotating the grating by a predetermined angle;
an objective lens for converging the three beams to form spots of the three beams on a recording surface of an optical disc;
optical path shifting means arranged between the light source and the objective lens, and adapted to shift respective optical paths of the three beams;
a collimating lens arranged between the optical path shifting means and the objective lens, and adapted to collimate the three beams;
a sectioned photodetector aligned with the optical path shifting means while being arranged in front or rear of the optical path shifting means, the photodetector including a main photodiode having four photodiode sections for receiving a main one of the three beams reflected from the optical disc via the optical path shifting means, and two sub photodiodes each having two photodiode sections for receiving an associated one of two side ones of the three reflected beams, to detect a tracking error signal, based on the received main and side beams; and
tracking control means for performing a tracking control operation, based on the tracking error signal from the photodetector, determining the type of the optical disc, and controlling the first rotating unit when it is determined that the optical disc is a DVD-RAM, to rotate the grating by the predetermined angle.

2. The tracking servo control apparatus according to claim 1, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

3. The tracking servo control apparatus according to claim 1, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

4. The tracking servo control apparatus according to claim 1, wherein the first rotating unit comprises an electromagnet adapted to rotate the grating in accordance with an amount of current applied thereto.

5. The tracking servo control apparatus according to claim 4, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

6. The tracking servo control apparatus according to claim 4, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

7. The tracking servo control apparatus according to claim 1, wherein the first rotating unit comprises a micro electro mechanical system (MEMS) element adapted to rotate the grating.

8. The tracking servo control apparatus according to claim 7, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

9. The tracking servo control apparatus according to claim 7, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

10. The tracking servo control apparatus according to claim 7, wherein the first rotating unit comprises an ultrasonic motor.

11. The tracking servo control apparatus according to claim 10, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

12. The tracking servo control apparatus according to claim 10, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

13. The tracking servo control apparatus according to claim 10, wherein the ultrasonic motor comprises:
a stator including a piezoelectric substrate having a continuously polarized structure to vibrate when an AC voltage is applied thereto, and a plurality of upwardly-extending protrusions bonded to the piezoelectric substrate while being circumferentially spaced apart from one another, and adapted to be vibrated in a predetermined direction in accordance with the vibrations of the piezoelectric substrate;
a rotor provided with a frictional pad at a lower end thereof, and arranged to be in frictional contact with respective upper ends of the protrusions to be rotated in accordance with a rotating force applied thereto from the stator, while holding the grating;
an ultrasonic motor control unit for controlling the stator to generate the rotating force.

14. The tracking servo control apparatus according to claim 13, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

15. The tracking servo control apparatus according to claim 13, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

16. The tracking servo control apparatus according to claim 10, wherein the ultrasonic motor comprises:
a piezoelectric vibrator including a piezoelectric member, and a non-elongation member bonded to the piezoelectric member, the piezoelectric vibrator being fixed at one end thereof;
a rotor provided with teeth along an outer peripheral surface thereof, while holding the grating;
an actuating member connected to the other end of the piezoelectric vibrator, and engaged with one of the teeth to rotate the rotor in accordance with a rotating force applied thereto from the piezoelectric vibrator; and
an ultrasonic motor control unit for controlling the piezoelectric vibrator to generate the rotating force.

17. The tracking servo control apparatus according to claim 16, further comprising:
a pair of second rotating units each adapted to rotate an associated one of the sub photodiodes included in the photodetector by a predetermined angle,
wherein the tracking servo control apparatus determines the type of the optical disc, and controls the second rotating units when it is determined that the optical disc is a DVD-RAM disc, to rotate the sub photodiodes by the predetermined angle.

18. The tracking servo control apparatus according to claim 16, further comprising:
a hologram optical element arranged upstream from the photodetector, and adapted to diffract the main and sub beams, thereby producing diffracted beams,
wherein the sub photodiodes are spaced apart from the hologram optical element by a distance shorter than a focal length of a 1st-order diffracted beam emerging from the hologram optical element, whereby the sub photodiodes receive the side beams in an enlarged state, respectively.

19. A tracking servo control method comprising the steps of:
(A) determining, by an optical pickup unit, whether an optical disc to be subjected to a reproducing or recording operation is a DVD-ROM or a DVD-RAM;
(B) if it is determined at the step (A) that the optical disc is a DVD-ROM, performing a tracking servo control operation; and
(C) if it is determined at the step (A) that the optical disc is a DVD-RAM, rotating a grating, and then performing the tracking servo control operation.

20. The tracking servo control method according to claim 19, further comprising the step of:
(D) rotating a sub photodiode adapted to receive the tracking error signal by a predetermined angle, after completion of the rotation of the grating at the step (C).

21. The tracking servo control method according to claim 19, wherein the step (B) comprises the steps of:
(B-1) if it is determined at the step (A) that the optical disc is a DVD-ROM, splitting the laser beam into three beams, and irradiating the three beams onto the optical disc;
(B-2) receiving the three beams reflected from the optical disc, and extracting a tracking error signal, based on the received three beams; and
(B-3) performing the tracking servo control operation, based on the tracking error signal.

22. The tracking servo control method according to claim 21, further comprising the step of:
(D) rotating a sub photodiode adapted to receive the tracking error signal by a predetermined angle, after completion of the rotation of the grating at the step (C).

23. The tracking servo control method according to claim 19, wherein the step (C) comprises the steps of:
(C-1) if it is determined at the step (A) that the optical disc is a DVD-RAM, rotating the grating by a predetermined angle;
(C-2) splitting the laser beam into three beams, and irradiating the three beams onto the optical disc;
(C-3) receiving the three beams reflected from the optical disc, and extracting a tracking error signal, based on the received three beams; and
(C-4) performing the tracking servo control operation, based on the tracking error signal.

24. The tracking servo control method according to claim 23, further comprising the step of:
(D) rotating a sub photodiode adapted to receive the tracking error signal by a predetermined angle, after completion of the rotation of the grating at the step (C).

25. The tracking servo control method according to claim 23, wherein the rotation of the grating at the step (C-1) is carried out by an electromagnet in accordance with a variation in the amount of current applied to the electromagnet.

26. The tracking servo control method according to claim 25, further comprising the step of:
(D) rotating a sub photodiode adapted to receive the tracking error signal by a predetermined angle, after completion of the rotation of the grating at the step (C).

27. The tracking servo control method according to claim 23, wherein the grating is a hologram grating, and the rotation of the grating at the step (C-1) is carried out by a micro electro mechanical system (MEMS) element.

28. The tracking servo control method according to claim 27, further comprising the step of:
(D) rotating a sub photodiode adapted to receive the tracking error signal by a predetermined angle, after completion of the rotation of the grating at the step (C).

29. The tracking servo control method according to claim 23, wherein the rotation of the grating at the step (C-1) is carried out by an ultrasonic motor.

30. The tracking servo control method according to claim 29, further comprising the step of:
(D) rotating a sub photodiode adapted to receive the tracking error signal by a predetermined angle, after completion of the rotation of the grating at the step (C).

31. A tracking servo control method comprising the steps of:
(A) determining, by an optical pickup unit, whether an optical disc to be subjected to a reproducing or recording operation is a DVD-ROM or a DVD-RAM;
(B) if it is determined at the step (A) that the optical disc is a DVD-ROM, performing a tracking servo control operation; and
(C) if it is determined at the step (A) that the optical disc is a DVD-RAM, rotating a grating adapted to split, into a main beam and sub beams, a light beam emitted from the optical pickup unit, and then performing the tracking servo control operation, using respective 1st-order diffracted beams of the side beams, which are enlarged while passing through a hologram optical element.
